(19) United States
(12) Patent Application Publication
(10) Pub. No.: US 2007/0011126 A1
(43) Pub. Date: Jan. 11, 2007

(54) Service-oriented architecture

(75) Inventors: Peter Conner, Rocklin, CA (US); Stewart Robinson, Edmonton (CA)

Correspondence Address: Trellis Intellectual Property Law Group, PC, 1900 EMBARCADERO ROAD, SUITE 109, PALO ALTO, CA, 94303, US

(73) Assignee: Primitive Logic, Inc., San Francisco, CA (US)

(21) Appl. No.: 11/388,624

(22) Filed: Mar. 21, 2006

Related U.S. Application Data
(60) Provisional application No. 60/664,250, filed on Mar. 21, 2005.

(51) Int. Cl. G06N 5/02

(52) U.S. Cl. 706/47

(57) ABSTRACT

A Service-oriented architecture (SOA) and accompanying method. In one embodiment, the SOA includes one or more service requesters coupled to one or more service providers via a bus. The bus includes runtime-binding functionality to facilitate interaction between the one or more service requesters and the one or more service providers. A registry, which stores information pertaining to a service provided by the one or more service providers, communicates with one or more service providers and/or requesters and the bus. In a more specific embodiment, bus includes a Service-Integration Bus (SIB) that includes a Service-Factory (SF) module for facilitating implementing the runtime binding functionality and for selectively invoking the service. Functionality of the SOA is strategically organized into various tiers and layers, including a requester tier, a provider tier, a business-process services tier, an infrastructure-services tier, an SIB layer, a persistence layer, and so on, to optimize system reusability, adaptability, and other desirable properties. A service interface pattern is described whereby a change in service implementation does not require modification to the manner in which the service is invoked by a requester

### CLAIM OF PRIORITY

This invention claims priority from U.S. Provisional Patent Application Ser. No. 60/664,250, entitled SERVICE ORIENTED ARCHITECTURE, filed on Mar. 21, 2005, which is hereby incorporated by reference as if set forth in full in this specification.

### BACKGROUND OF THE INVENTION

This invention is related in general to computing and more specifically to service-oriented architectures employed to facilitate implementing and/or integrating computer programs, such as enterprise software applications.

A Service-Oriented Architecture (SOA) may be any design or specification for sharing data and/or processes in a network or other computing environment. SOAs are employed in various demanding applications, including Web services shared via enterprise networks, distributed computing, corroborative research applications, and so on. Such applications often demand agile systems and method for efficiently integrating various distinct programs. Such programs, also called applications, are often implemented as services that are usable by other applications. A service may include a function, such as processing a purchase order or performing a scientific calculation.

Agile, versatile, and modular SOAs are particularly important in enterprise applications, where legacy systems and monolithic programs are widespread. For the purposes of the present discussion, a legacy system is a preexisting system or application that a user, such as a business, wishes to keep rather than replacing with a newer or redesigned system. A monolithic program may be an application that has few or no features designed to facilitate sharing of services and other resources with other applications.

Conventionally, businesses wishing to implement emerging computing applications must adapt to new computing architectures. Unfortunately, adapting to new computing architectures often requires discarding legacy systems, which is often prohibitively costly or may necessitate business downtime. Alternatively, legacy systems are often completely redesigned to work with different types of emerging service applications. Unfortunately, redesigning software is undesirably costly and inefficient. Consequently, various barriers to integrating applications remain.

Alternatively, businesses may employ various SOAs to address some application-integration problems. Unfortunately, existing SOAs often lack important features for ensuring maximum application reusability, interoperability, scalability, flexibility, and agility.

### SUMMARY OF EMBODIMENTS OF THE INVENTION

Embodiments of the invention include various design approaches to SOA and an overall design methodology for achieving an efficient SOA. Various features can be used to advantage with Web services, database accessing, legacy and third party software, and other types of components.

In one embodiment, the SOA includes a bus that interfaces one or more service requesters with one or more service providers. The bus includes runtime-binding functionality to facilitate interaction between the one or more service requesters and the one or more service providers. A registry, which stores information pertaining to a service offered by the one or more service providers, communicates with one or more service providers and/or requesters and the bus.

In a more specific embodiment, the bus is implemented via a Service-Integration Bus (SIB) that includes a Service-Factory (SF) module for facilitating implementing the runtime binding functionality and for selectively invoking the service. Functionality of the SOA is strategically organized into various tiers and layers, including a requester tier, a provider tier, a business-process services tier, an infrastructure-services tier, an SIB layer, a persistence layer, and so on, to optimize system reusability, adaptability, and other desirable properties.

In another embodiment, a service interface pattern is described whereby a change in service implementation does not require modification to the manner in which the service is invoked by a requester.

Accordingly SOAs constructed according to certain embodiments of the present invention may exhibit various benefits, including providing an architecture which is readily adaptable to businesses and other applications, rather than requiring businesses to adapt to the architecture. Such SOAs may maximize use of existing products to satisfy a given system implementation. Accordingly, SOAs constructed according to certain embodiments of the present invention may be readily, quickly, and cost-effectively adapted to new services and requirements.

### BRIEF DESCRIPTION OF THE DRAWINGS

FIG. 1 is a diagram of a Service-Oriented Architecture (SOA) according to an embodiment of the present invention.

FIG. 2 is a diagram illustrating exemplary interactions between certain modules of an alternative implementation of the SOA of FIG. 1.

FIG. 3 is a diagram illustrating a simplified SOA that retains exemplary key features of the SOAs of FIGS. 1 and 2.

FIG. 4 is a flow diagram of a method adapted for use with the SOAs of FIGS. 1-3.

FIG. 5 illustrates an initial deployment of a service interface pattern.

FIG. 6 shows the same components and interfaces of FIG. 5 after the service deployment has been changed.

FIG. 7 shows a new service mapping for new an added requester.

### DETAILED DESCRIPTION OF EMBODIMENTS OF THE INVENTION

Details of embodiments of the present invention are described in various papers, including:
“Primitive Logic SOA Reference, Introduction, Services-Oriented Architecture Document,” Version 1.0, Mar. 1, 2005, 19 pages;
“Primitive Logic SOA Reference, Service Integration Bus, Services-Oriented Architecture Document,” Version 1.0, Mar. 1, 2005, 27 pages;
“Primitive Logic SOA Reference, Enterprise Object Definition and Relationship Management, Services-Oriented Architecture Document,” Version 1.0, Mar. 1, 2005, 18 pages;
“Primitive Logic SOA Reference, Persistence, Services-Oriented Architecture Document,” Version 1.0, Mar. 1, 2005, 8 pages;
“Primitive Logic SOA Reference, Facet Design Pattern, Services-Oriented Architecture Document,” Version 1.0, Mar. 1, 2005, 14 pages; and
“Service-oriented Architecture and Reference Implementation White Paper,” Jan. 10, 2005, Version 0.02, 10 pages.
“Services-Oriented Architecture Document,” Version 1.2, Mar. 4, 2006, 24 pages.

For clarity, various well-known components, such as power supplies, modems, routers, Internet Service Providers (ISPs), browsers, standby modules, and so on, have been omitted from the figures. However, those skilled in the art with access to the present teachings will know which components to implement and how to implement them to meet the needs of a given application.

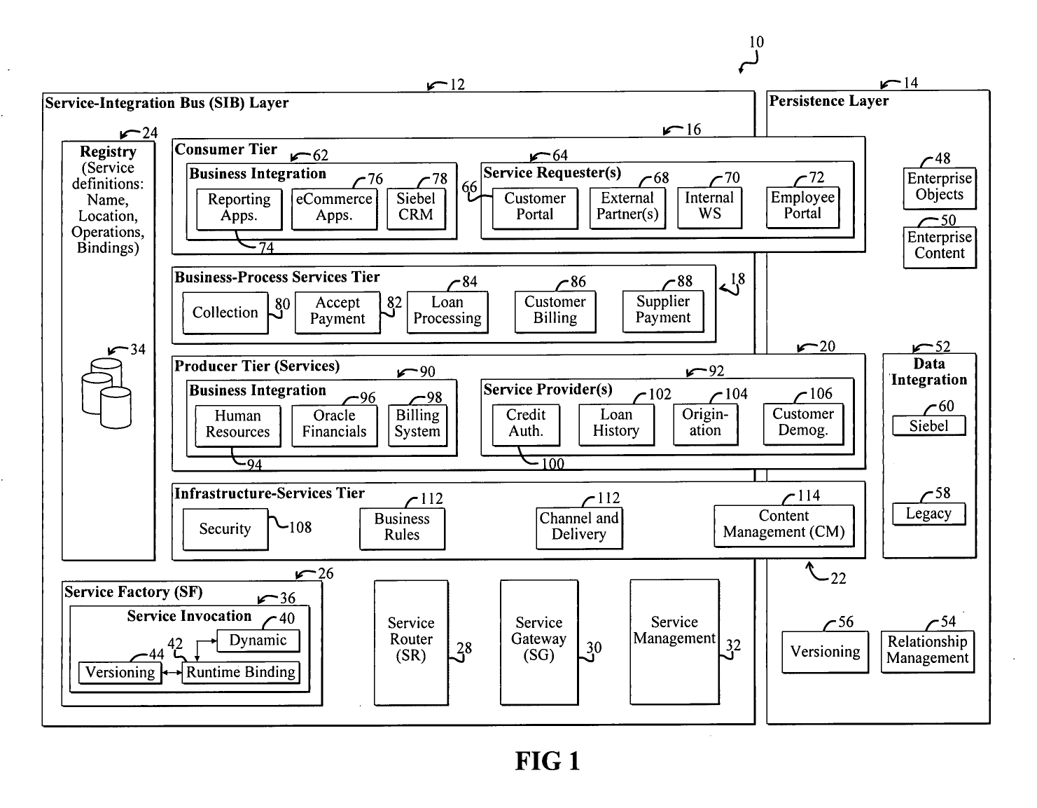

FIG. 1 is a diagram of a Service-Oriented Architecture (SOA) 10 according to an embodiment of the present invention. The SOA 10 includes various layers 12, 14 that interface various tiers 16-22. The tiers include a consumer tier 16, a business-process-services tier 18, a producer tier 20, and an infrastructure-services tier 22. The layers 12, 14 include a Service Integration Bus (SIB) layer 12, which interfaces the tiers 16-22, and a persistence layer 14, which interfaces the consumer tier 16, the producer tier 20, and the infrastructure-services tier 22.

For the purposes of the present discussion, a tier may be any grouping of modules or functionality, defined physically and/or logically. A module may be any feature, program, or named grouping of functionality. Tiers are used to organize and provide functionality or capability in the architecture. A layer may be any functionality that facilitates interfacing or communicating with one or more tiers. The number, type and organization of layers, tiers, modules, and other structures can vary in different embodiments. Generally, in FIG. 1, tiers are shown horizontally oriented, while layers are shown vertically oriented.

The SIB layer 12 includes a registry 24, a Service-Factory (SF) module 26, a Service-Router (SR) module 28, a Service-Gateway (SG) module 30, and a Service Management (SM) module 32. The registry 24 includes service definitions 34. The SF module 26 includes a service-invocation module 36, which includes a dynamic-invocation module 40, a runtime-binding module 42, and a first versioning module 44. The runtime-binding module 42 is coupled between the versioning module 44 and the dynamic-invocation module 40. The SF module 26 and the SR 28 comprise part of a service-invocation framework.

The SF module 26 includes one or more routines for facilitating service-invocation via dynamic runtime binding. Accordingly, it includes some versioning capabilities, which are represented via the versioning module 44. The SF module 26 can be used in the context of a service-interface pattern or method, which is employed to implement certain versioning capabilities or otherwise contributes its own versioning capabilities to the SOA 10.

The persistence layer 14 operates on enterprise objects 48, and includes an enterprise-content module 50, a data-integration module 52, a relationship-management module 54, and an enterprise-object versioning module 56. For illustrative purposes, the data-integration module 52 is shown including a data-integration with a Siebel Web legacy system 60, and other legacy applications 58.

A legacy service requester may be any legacy application that requires access to a service. Similarly, a legacy service provider may be any legacy application that needs to be exposed as a service. The terms legacy service requester and consumer legacy application are employed interchangeably herein. Similarly, the terms legacy service provider and producer legacy application are employed interchangeably.

For the purposes of the present discussion, a legacy application may be any preexisting or third party application, such as a service provider or service requester. Legacy consumers or producers are usually not specifically designed for a given SOA. A consumer may be any entity, such as a software or hardware application, that uses a service, such as a Web service provided by a service provider. A consumer may be a service requester and vice versa. A producer may be any entity that provides a service.

The consumer tier 16 includes a first business-integration module or layer 62 and service requesters 64. For illustrative purposes, the first business-integration layer 62 is shown including reporting applications 74, eCommerce applications 76, and a Siebel Customer-Relationship Management (CRM) module 78. The service requesters 64 are shown including a customer portal 66, an external partner 68, an internal Web service 70, and an employee portal 72. In the present specific embodiment, the employee portal 72 is further incorporated within the persistence layer 14. Generally, legacy systems need not employ the persistence layer 14. Service requesters 64 and service providers 92, however, may employ the persistence layer 14.

For illustrative purposes, the business-process services tier 18 is shown including a collection module 80, a payment-acceptance module 82, a loan-processing module 84, a customer-billing module 86, and a supplier-payment module 88. The business-process services tier 18 of FIG. 1 may coordinate communications between components in other tiers 16, 20, 22 as shown in FIG. 1. The business-processes services tier 18 employs a Business Process Execution Language (BPEL)-compliant business process management engine (BPME).

In the present specific embodiment, the producer tier 20, also called a provider tier, includes a second business-integration layer or module 90 and service providers 92. For illustrative purposes, the second business-integration layer or module 90 is shown including a Human-Resources module 94, an Oracle^{(R)} financial database 96, and a billing system 98. The service providers 92 include a credit-authorization module 100, a loan-history database 102, an origination module 104, and a customer-demography database 106.

For illustrative purposes, the infrastructure services tier 22 is shown including a security module 108, a business-rules module 10, a channel and delivery module 112, and a Content Management (CM) module 114.

In operation, the SOA provides a flexible, versatile, modular, and cost-effective architecture that is readily adaptable to the needs of businesses or other users. The agility of the SOA 10 is particularly enhanced by the use of the SIB 12 and accompanying SF module 26, SR 28, and SG 30, which facilitate runtime binding and service-invocation functions as discussed more fully below. When service providers 92, also called producers, connect to the SOA 10, they publish information, such as definitions 34 pertaining to offered services, to the registry 24. For the purposes of the present discussion, a registry may be any database or other repository of information.

Generally, modules 90, 92 in the producer tier 20 publish information pertaining to offered services to the registry 24. The business integration layer 90 facilitates publishing operations for legacy applications.

The SR 28 includes one or more routines for facilitating publishing of service definitions 34 to the registry 24. When a requester 64 attempts to use a service provided by a provider 92, the SF module 26 facilitates consumer-side runtime binding, which may enable powerful Quality-Of Service (QOS) and version-management capabilities. Generally, the SF module 26 is used by the business-integration layers 62, 90 to allow legacy applications to consume services in the producer tier 20.

For the purposes of the present discussion, runtime binding may be the association of certain information with an entity before or during running the entity, if it is executable, or before running an application that employs the entity. For example, the SF module 26 may employ a type of runtime binding, wherein a given service request is associated with published definitions 34 pertaining to a service provider 92 that can fulfill the request. For example, the SF module 26 may access the registry 24 to retrieve a service definition 34; then parse the definition; then employ certain open-source code to create a proxy that interfaces the service requester 64 with the service provider 92, as discussed more fully below. The proxy may be implemented as a Java object that is operated on by the service requester, also called the client or the consumer. An SF module 26 may be any module that is capable of selectively implementing runtime binding, such as in response to receipt of a service request by one or more of the service requesters 64.

A programming object, such as a Java object, may be any class or other programming-language structure that may be passed between routines or modules in a computing environment.

Consumer-side runtime binding may be any runtime-binding functionality that is implemented via one or more processes running on a consumer module or is otherwise not implemented via process running on a service provider or producer module. Consumers may include both requesters that have been specifically built to use services in the producer tier 20 and legacy applications that are enabled by the first business-integration layer 62 to use services in the producer tier 20. The terms consumer and service requester are employed interchangeably. Furthermore, the terms service provider and producer are employed interchangeably.

The business-integration layers 62, 90 facilitate interfacing one or more legacy requesters with one or more service providers 92 or interfacing one or more legacy providers with one or more requesters 64. Legacy providers expose or publish their services to the registry 24 via the second business-integration layer 90. Similarly service requests from legacy requesters are routed through the first service-integration layer 62 before their requests invoke requested services through the SIB layer 12 and accompanying service-invocation framework 26, 28.

In the present specific embodiment, the service definitions 34 in the registry 24 conform to W3C Web Services Definition Language (WSDL) and employ binding extensions to define services, such as by service name, location, operations, and bindings. The registry 24 acts as a repository for service-provider information and further employs open-source technologies, such as UDDI4J and WSDL4J, to access and maintain service definitions.

The persistence layer 14 acts as an abstraction layer that facilitates maintaining enterprise objects 48, performing mapping between objects and relational databases, performing certain versioning functions via the enterprise-object versioning module 56, and so on. The persistence layer 14 may employ certain known software, such as Service Data Objects (SDO) to facilitate implementing various features. While versioning functionality, as represented by the enterprise-object versioning module 56, is shown implemented in the persistence layer 14 and the SF module 26 of the SIB layer 12, service-versioning functionality may be implemented in one layer or another or both layers 12, 14, without departing from the scope of the present invention.

Generally, versioning capabilities of the SF 26 of FIG. 1 insulate consumers, such as service requesters 64, from changes to service definitions, as does the service-interface pattern, as discussed more fully below. Persistence versioning implemented via the enterprise-object versioning module 56 involves maintaining different versions of a specific enterprise object.

Versioning functionality may be any software and/or hardware features capable of adjusting an interface or behavior thereof based on a version of an application employing the interface. For example, certain requesters 64 or providers 92 may require that certain versions of services be employed for a given operation. Versioning functionality incorporated in the first versioning module 44 and/or the enterprise-object versioning module 56 may ensure that appropriate service versions are employed by other services.

The persistence layer 14 may further selectively manipulate various coarse-grained objects employed by various modules and applications in the SOA 10 to discriminate what each module and/or application needs. For example, certain coarse-grained objects may have multiple dependent objects. A given application may not need to access the dependent objects. Accordingly, the relationship-management module 54 of the persistence layer 14 may work with the service providers to facilitate only passing necessary portions of the object to a given application. The persistence layer 14 also acts as a warehouse for enterprise content, which is employed by the CM module 114 to facilitate managing service content employed by the SOA 10. Generally, the CM module 114 deals with content and not enterprise objects.

For the purposes of the present discussion, a coarse-grained object may be a self-sufficient object that manages its relationships to other objects. A coarse-grained object may reference or contain one or more other objects and may manage the life cycle of the one or more other objects, which are often called dependent objects.

The infrastructure-services layer 22 may implement various functionality that may be employed by various tiers 16-22 and layers 12, 14. Examples of such functionality include authentication, authorization, encryption and decryption functionality implemented via the security module 108; externalization of business rules are implemented via the business-rules module 110; transmission of correspondence between components of the SOA 10 via the channel-and-delivery module 112; and content-management functionality employed by the CM module 114.

Various functionality implemented in the SIB layer 12, such as the service-invocation framework 26, 28 facilitate invoking services dynamically via the dynamic-invocation module 40. During dynamic invocation, bindings are resolved at runtime by the SF module 26 via the runtime-binding module 42 and the versioning module 44, which communicate with the registry 24.

For the purposes of the present discussion, a Service Integration Bus (SIB) may be any bus or other mechanism for interfacing one or more tiers and/or applications, such as applications that use and/or provide one or more services. A service may be any function or combination of functions performed by a program or other application. A service may be implemented via a centralized, distributed, or other type of implementation without departing from the scope of the present invention.

A service requester may be any application, such as one or more hardware and/or software modules or components, that issues a request for resources or is otherwise provide resources from an external source. Generally, in the present embodiment, a service requester invokes services or business processes only.

Resources may be results of a computation, output from an application, such as a service provider, and so on. A service provider may be any application, such as one or more hardware and/or software modules that can output or otherwise provide one or more resources, such as a service. An example of a service provider is an application that performs credit card processing on behalf of a service requester, such as a credit-card-charging terminal.

The SG module 30 includes one or more routines for facilitating runtime mediation for various services, such as Web Services implemented via requesters 64 and/or providers 92. Generally, in the present specific embodiment, SG module 30 only provides runtime-binding capabilities to Web-service clients.

For the purposes of the present discussion, runtime mediation may be any interfacing or coordination performed between applications during and/or near when the applications are running and attempt to share resources, such as information or services, or other communications. A Web-service may be a service that communicates with one or more clients through a set of standard protocols and technologies. Certain Web services may be implemented in various often ubiquitous platforms and products offered by various software vendors.

Hence, components in the various tiers 16-22 may work together via the SIB layer 12. Key components of the SIB 12 include:

1. The registry 24, which contains service definitions 34 conforming to the W3C Web Services Definition Language (WSDL) specification with binding extensions to define service names, locations, operations and bindings.

2. The SF module 26, which in the present specific embodiment, includes a Java component that is built into service requesters or the business-integration layer 20 to facilitate providing runtime binding to service providers 92 for service consumers 64 and legacy applications.

3. The SR 28 publishes service definitions to the registry 24 for service providers 92 and legacy applications in the producer tier 16.

4. The SG 30 provides runtime mediation for WS clients, such as service requesters that request Web services.

5. The service-management module 32 monitors and manages service providers 92.

Several keynote capabilities of the SOA 10 are highlighted in FIG. 1 and include:

1. Runtime binding between service consumers 64 and service providers 92.

2. Business-integration capabilities 62, 90 to allow legacy systems to participate in the architecture 10 as service consumers 64 or providers 92.

3. Business-process management capabilities 18, which are provided via the business-process services tier 18.

Hence, FIG. 1 illustrates an SOA 10 that includes four architectural tiers 16-22. The consumer tier 16 includes the service requesters 64 that support user interaction with the SOA 10, including external systems 68 that operate as service requesters 64. A portion of this tier 16 represents service requesters 64, such as the various portals, that interact natively with the SOA as Java implementations.

The business-process services tier 18 includes services that orchestrate the interaction of various requesters 64 through appropriate portals. The service providers 92 are implemented in the producer tier 20. The SOA 10 provides direct architectural support, using business process orchestration and automation, for long running business processes and for business process automation.

The business-process services tier 18 can be implemented using elements of product suites that manage the business-process orchestration between the consumer tier 16 and services in the producer tier 20. Some business solutions may not require support from this tier 18 if the business process is short running.

In the present specific embodiment, the producer tier 20 includes service providers that implement and provide the basic business logic required to run a business. In a preferred embodiment, the SOA 10 provides architectural support for both native service providers and legacy systems that are exposed as SOA business services by the SIB 12 and the business-process services tier 18. The support can be provided by any suitable components or methods as, for example, by using various tools, such as WebSphere Process™ Server and Message Broker™.

The infrastructure-services tier 22 includes service providers that have broad-based reusability across many different parts of the business and are infrastructure and not business in nature. Several service providers have been identified as exemplary infrastructure services, including security 108, business rules 110, channel and delivery 112, and content management 114 services.

The SOA 10 also defines four discrete architectural layers that are shown as overlays in FIG. 1. A given service request may progress through successive lower layers and then back up again in order to access a service provider or other objects or software components that provide functionality.

The SIB 12 enables and supports interactions between service consumers 16 and service producers 20. The persistence layer 14 stores the enterprise objects 48 and their relationships, and is accessed directly by native, or Java-based, service requesters 64 and service providers 92.

The registry 24 is layered atop the SIB 12 and operates as a repository for service provider service definitions 34. The registry 24 is accessed by service requesters and service providers through the SIB 12.

Business-integration layers 62, 90 allow non-native, legacy environments to participate as service requesters 64, service providers 92, thereby extending the capabilities of the SOA 10 with integration capabilities for legacy environments.

Names of various tiers and features of embodiments of the present invention may be changed without departing from the scope of the present invention.

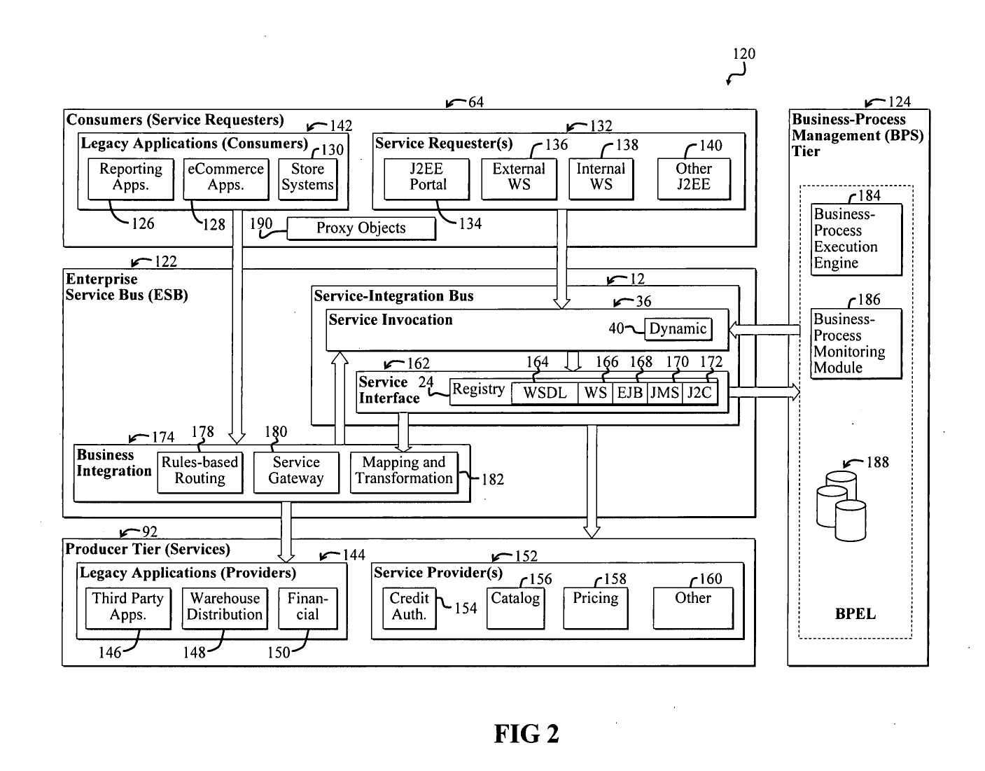

FIG. 2 is a diagram illustrating exemplary interactions between certain modules of an alternative depiction or implementation 120 of the SOA 10 of FIG. 1. Generally, arrows in FIG. 2 illustrate exemplary directions of invocation, i.e., directions in which certain messages pass to facilitate invoking a service.

The SOA 120 includes consumers 64 and producers 92, which are interfaced via an Enterprise Service Bus (ESB) 122. The term ESB is common industry term. However, FIG. 2 illustrates how the SOA 10 of FIG. 1 can be depicted in terms of an ESB. A Business-Process Management (BPM) tier 124 communicates with the ESB 122.

For illustrative purposes, the consumers 64 are shown including legacy consumers 142, such as reporting applications 126, eCommerce applications 128, and storage systems 130. The consumers 142 further include other service requesters 132, such as a Java 2 Enterprise Edition (J2EE) portal 134, an external WS 136, an internal WS 138, and another J2EE application 140. Similarly, the producers include legacy producers 144, such as third-party applications 146, a warehouse distribution program 148, and a financial-services module 150. The producers further include other service providers 152, such as a credit-authorization module 154, a catalog application 156, a pricing application 158, and another type of application 160.

The ESB 122 incorporates the SIB 12. The SIB 12 is shown including the service-invocation feature or module 36 and a service-interface module or feature 162, which includes the registry 24. The registry 24 is shown including exemplary WSDL definitions for different producers 92 and consumers 64. The WSDL definitions include WS definitions, Enterprise Java Beans (EJB) definitions 168, Java Message Service (JMS) definitions, and definitions 172 for J2EE Connector (J2C) resource adapters. The service-invocation module 36 includes the dynamic-invocation module 40. The ESB 122 further includes a consolidated business-integration layer or module 174, which may incorporate functionality of the first business-integration module 62 and the second business-integration module 90 of FIG. 1.

The consolidated business-integration layer 174 further includes a rules-based routing module 178 and a mapping and transformation module 182. The service gateway 180 may facilitate incorporating non-Web services, i.e., providers and/or requesters that are not Web services, into the SOA 120. The business-integration layer 174 further includes a mapping-and-transformation module 182.

The BPM tier 124 includes business processes 184, 186, which are created via Business-Process Execution Language (BPEL) tooling. The BPM tier 124 has a business-process-execution engine 184 and a business-process monitoring module 186.

While the present embodiments are discussed with respect to business applications, applications of the SOAs 10, 120 are not limited thereto. Other applications, such as university or government applications may employ SOAs constructed according to embodiments of the present invention without departing from the scope thereof.

Additional modules or layers, such as modules for implementing authentication, encryption, and so on, may be incorporated in the SOA 120 without departing from the scope of the present invention. Various modules, tiers, and layers shown in FIGS. 1-2 may be readily implemented by those skilled in the art with access to the present teachings without undue experimentation. Exact implementation details of various modules are application specific and may be readily determined by those skilled in the art to meet the needs of a given application.

In operation, the business-integration layer 174 interfaces legacy applications, including legacy consumers 142 and legacy producers 144, with the SIB 12 to facilitate publishing and accessing services without requiring specific knowledge of implementation details pertaining to requested or provided services. The SIB 12 implements various functions, such as runtime binding and dynamic service-invocation to facilitate interfacing consumers 64 with producers 92 and enhancing the agility of the overall SOA 120.

The service requesters 132 are shown including or communicating with proxy objects, which result from runtime binding operations invoked via the dynamic-invocation module 40 running on the service-invocation module 36 of the SIB 12. The proxy objects may be programming objects that provide a layer of abstraction and a consistent way for consumers 64 to communicate with producers 92 without requiring additional special modifications. Interfacing details are handled by the service-invocation module 36, which communicates with the BPM tier 124 as needed, such as to retrieve the business process definitions 188 to facilitate constructing the proxy objects 190.

In summary, with reference to FIGS. 1 and 2, each of the SOAs 10, 120 may be considered an architecture that includes a first tier 16, which includes a requester 64 of a service; a second tier 20, which includes a provider 92 of a service; and a first layer 12 interfacing the first tier 16 and the second tier 20. The first layer 12 includes a registry 24 adapted to store information 34, 188 pertaining to the service and a first module 26, 28 adapted to employ the information to facilitate interaction between the requester 64 and the provider 92.

The first module 26, 28 includes a Service Factory (SF) 26. The information includes a definition 34, 188 of the service. The SF module 26 includes runtime-binding functionality 42 that associates the service requested by the requester 64 with a proxy 190. The proxy 190 is adapted to interface the requester 64 with the provider 92, thereby obviating the need for the requester 64 to be specifically modified to accept services directly from the provider 92.

The SF module 26 includes a service-invocation module 36 for selectively invoking the service in response to a request issued by the requester 64. The requester 64 includes a first legacy system 142. The SOA further includes a first layer further includes a first business integration module 62, 174 interfacing the first legacy system 64, 142 with the registry 24, 188.

The provider 92 includes a second legacy system 92, 144. A second business integration module 90, 174 interfaces the second legacy system 92, 144 with the registry 24, 188. The first layer further includes a service router 28 that is adapted to facilitate publishing the information to the registry 24, 188. The proxy 190 is implemented via a programming object.

The SOA 10, 120 further includes a business-process services tier 18. The business-process services tier 18 includes one or more modules 80-88 adapted to manage communications between a consumer tier 64 and a producer tier 92. The first tier 16, 64 represents the consumer tier 16, 64, and the second tier 20, 92 represents the producer tier 20, 92. The SOA 10, 120 further includes an infrastructure-services tier 22, and a persistence layer 14 coupled between the consumer tier 16, 64, the producer tier 20, 92, and the infrastructure-services tier 22. The persistence layer 14 further includes versioning functionality in addition to a content management module 114, which is further incorporated in the infrastructure-services tier 22.

Consumers 64 may include service requesters 132 that directly work together with other components, and may include the legacy systems 142 that interoperate indirectly other components through the business integration layer 174. Similarly, producers or service providers 92 may include providers 152 that expose their services directly to the service interface 162 and BPM tier 124 or other mechanism, and may include the legacy systems 144 that require the business-integration layer 174 to expose their services to consumers 64.

The SOA 120 dramatically extends capabilities of the ESB 122 over certain conventional ESB designs, to include features of the SIB 12 in addition to the business-integration layer 174, which provides integration support for both consumers 64 and producers 92.

In the present specific embodiment, service invocation implemented via the service-invocation module 36 is dynamic. With dynamic invocation, the service consumer 64 incorporates the SF module 26, as shown in FIG. 1, and the binding is resolved at runtime by the SF module 26.

The SOAs 10, 120 of FIGS. 1 and 2 selectively implement consumer-side runtime binding capabilities via the SF module 26, which may enable or enhance Quality of Service (QOS) and version-management capabilities of the SOA and associated system implementation.

Generally, service providers 92 expose WSDL (W3C Web Services Definition Language) compliant service interfaces via the service interface 162 in preparation for invocation by the service-invocation module 36. These service interfaces 164 may be implemented, for example, using a WS, session Enterprise JavaBeans (EJB), a Java Message Service (JMS), or using a Java 2 Enterprise Edition (J2EE) Connector (J2C) adapter.

When the SF module 26 of FIG. 1 is used, the SF module 26 determines the types of bindings exposed by the service provider 152 and then selects the appropriate binding, which may be based on based time-of-day, performance needs, or other considerations. The consumer 64 simply invokes a method on the Java interface 162, which represents the service provider 92. If the consumer 64 binds to the service provider 92 statically, then the consumer 64 must know the implementation details of the interface at design time and build to the specifics of the implementation.

Certain business integration functionality, such as functionality implemented via the business-integration layer 174, may be satisfied by one or more third-party business-integration products that conform to desired qualities of the SOA 120. Preferably, the selected third-party product(s) provide legacy adapters or an adapter tool kit, and any necessary process-automation tooling with mapping and transformation features. The selected product(s) preferably can expose, as a legacy service provider, a service-interface implementation that is supported by the SOA 120. The SF module 26 may be employed by certain products to dynamically bind to a service provider 92 when the business-integration layer 174 is supporting legacy service consumers 142.

When a business process executes on a Business Process Management Engine (BPME) the process is naturally exposed to service consumers 64 as a Web service via Simple Object Access Protocol (SOAP). The business process may invoke partners, such as service providers 92 and consumers 64, as Web services. The SG functionality 30 of the SIB 12 may provide enable non-Web service partners to participate in the SOA 120. Some BPMEs provide BPEL extensions that support Java-written nodes in the process flow that could incorporate an SF to dynamically access non-Web service partners.

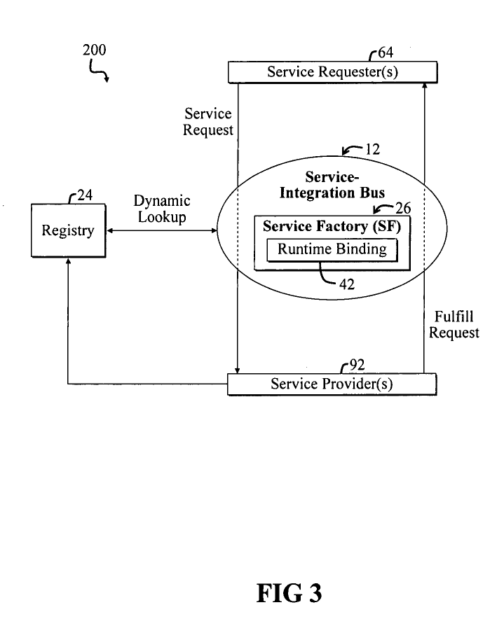

FIG. 3 is a diagram illustrating a simplified SOA 200 that retains certain exemplary features of the SOAs 10, 120 of FIGS. 1 and 2. The SOA 200 includes a service requester 64, a service provider 92, a registry 24, and the Service-Integration Bus (SIB) 12. The SIB 12 acts as an interface between the service requester 64 and the service provider 92. The SIB 12 employs information, from the registry 24, pertaining to one or more services that have been registered by the service provider 92. The SIB 12 incorporates the Service Factory (SF) 26 and accompanying runtime-binding module 42.

Generally, the service provider 92 publishes service definitions and any other information necessary to enable the SF module 26 to perform runtime binding and create requisite interface objects to facilitate communications between the service requester 64 and provider 92. Certain modules in the SIB 12, such as the SF module 26, may dynamically lookup service information in the registry 24 as needed to facilitate use of a service by the service requestor 64.

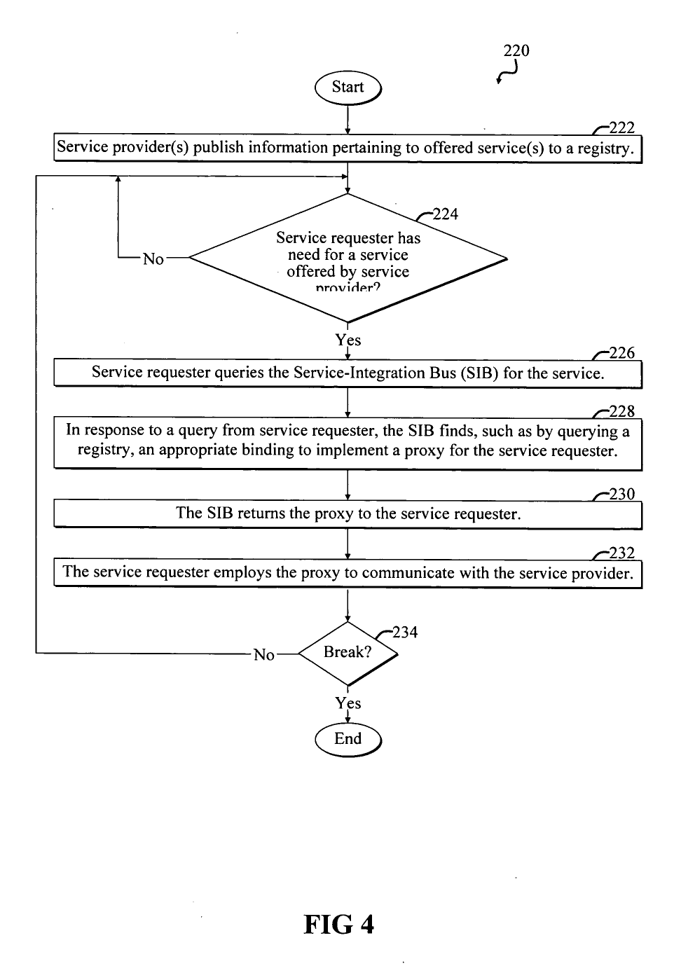

FIG. 4 is a flow diagram of a method 220 adapted for use with the SOAs 10, 120, 200 of FIGS. 1-3. The method 220 includes an initial publishing step 222, wherein a service provider publishes information pertaining to offered services to a registry. Subsequently, a request-checking step 224 determines whether a service requester has a need for a service provided by a service provider. If a service requester does not need a service offered by a service provider, then step 224 continues unless a system-break occurs. A system break occurs when the accompanying SOA is disabled or otherwise not available or operating. If a service requester desires a service offered by a service provider, then a querying step 226 is performed.

The querying step 226 involves the service requester querying the SIB for the service.

A subsequent binding step 228 involves the SIB finding, in response to a query from the service requester, an appropriate binding to implement a proxy for use by the service requester to access a desired service

Next, a proxy-returning step 230 involves the SIB returning the proxy to the service requester.

Subsequently, in a providing step 232, the service requester employs the proxy to communicate with the service provider.

In summary, the SIB queries for a service definition and bindings for a service requested by a requester; decides which binding to use; creates a proxy; returns the proxy to the requester; and then the requester uses that proxy to communicate with the provider.

With reference to FIGS. 1-4, certain embodiments of the present invention provide various Architecturally Significant Features (ASFs), such as modules, tiers, and layers, that perform various tasks, such as service invocation, marshalling and unmarshalling of resources, and registry operations.

Generally, service requestors facilitate discovering and invoking services offered by service providers 92 via ASFs. The SOAs 10, 120, 200 facilitate decoupling dependencies of applications on specific platforms and runtime environments. Furthermore, integration barriers, such as between service requesters 64 and service providers 92 are broken down.

A given service provider may include a cohesive set of business functions that are collocated for external access across a variety of transports. Service providers describe their interfaces and location via one or more registries so as to enable discovery at runtime by requesters of their services, i.e., service requesters. Certain service providers can operate on self-describing coarse-grained objects instead of operating on lists of parameters. This may reduce the impact of changes to objects and service-provider interfaces and processing. Often, changes to objects may not require changes to codes, such as service-provider interfaces and processing, that employ the objects.

Certain SOAs constructed according to embodiments of the present invention may employ tiers and layers to maintain clear separation of user interaction, business logic, and business information. The resulting SOAs are agile and adaptable, enabling cost-effective changes in business requirements and services. Furthermore, the SOAs may eliminate redundancies and inconsistencies in business processing and business information by employing adaptive architecture and best practices.

The SOAs may eliminate point-to-point and brittle interface aspects of existing integration touch points; may promotes the reuse of legacy systems by facilitating cost-effective adaptation to existing architecture; and may promote adherence to and leverage of open standards and technologies.

Generally, when building an SOA in accordance with the present teachings, the architecture is evaluated in light of various principles and objectives as the architecture and/or accompanying system implementation is being designed or constructed. Exemplary principles and objectives include:
Re-use existing infrastructure whenever possible, emphasizing reuse and re-composition.
Acquire free, where possible, robust, flexible, and cost-effective public-domain technologies.
Acquire at cost from vendors offering technology that conforms to the present requirements.
Build applications and technology when otherwise not sufficiently cost effective or practical to acquire via other ways.
Architect for cost effective change and agility.
   Eliminate redundancies and inconsistencies in processing and information.
   Eliminate brittle connections (e.g., Application Programming Interfaces).
   Reuse existing systems when they can be architecturally and cost effectively adapted.
   Adhere to and leverage open standards and technologies.
   Buy products and tools that can be adapted to the architecture when it reduces time to market and is cost effective (buy vs. build).
Construct the system implemented via the SOA as a set of services.
   Expose a highly cohesive set of business functions for external access.
   Employ self-describing services.
   Employ self-describing information, such as self-describing objects.
   Employ loose coupling between modules, features, tiers, and layers.
      Composition perspective—avoid client dependencies.
      Integration perspective—adaptable, chameleon-like, less reliance on predefined interfaces and interactions, discoverable at run-time.
   Employ coarse-grained objects
      SOA is applied at a coarse grain (Services/Service Request or Service Domain/Service).
      Use coarse-grained objects to provide building blocks for collaborative business processes.
      Employ coarse-grained objects to maximize SOA performance.
      Pass self-describing objects and documents instead of parameters.
         Employ self-describing interactions, such as via eXtensible Markup Language (XML), to facilitate Electronic Data Interchange (EDI).

With reference to FIGS. 1 and 2, particularly useful modules of the SIB 12 include the SF module 26, the SR 28, and the registry 24. In supporting roles, authentication and authorization functionality implemented via the security module 108 of the infrastructure-services tier 22 of FIG. 1, facilities controlling access to service providers 92 and may provide a single sign-on capability of service-provider implementations. Encryption/decryption functionality implemented via the security module 108 may ensure that data is secured SOAs 10, 120 and accompanying enterprise, and so on. The relationship-management module 54 may break up an object graph for easier transmission of the objects across the SIB 12.

The event management and messaging functionality, which may be implemented via the service-management module 32 and other modules, may provide the backbone protocol for transmission of requests and responses through the SIB 12. Various business services, such as those implemented via the consumer tier 64 and the producer tier 92, run on tip of various facilities provided by the SIB 12. The business services 92, 94 are then exposed through the SIB 12 to be consumed by requestors 64. Note that certain requesters 64 may act as providers 92 and vice versa without departing from the scope of the present invention.

The SOAs 10, 120 may include various Architecturally Significant Features (ASFs), such as those described below in the following tables.

TABLE 1
Service Integration Bus ASFs

| ASF | Description |
|---|---|
| Service | The mechanism by which Service Requestors are able to |
| Invocation | request that Service Invocations be executed by Service |
| | Providers. |
| Marshalling/ | The mechanism by which data and/or objects are |
| Unmarshalling | converted to a standardized, interoperable, cross-platform |
| | format for transmission between Requesters and |
| | Providers. |
| Registry | A repository for WSDL and eXtensible markup language |
| | Schema Definition (XSD) meta-data descriptions of |
| | Service Providers including bindings, location, and other |
| | details necessary for Service invocation. |
| Event | A low level messaging infrastructure for |
| Management | publish/subscribe types of operations. |

TABLE 2
Persistence ASFs

| ASF | Description |
|---|---|
| Persistence | The means by which an Object persists beyond a process |
| | boundary. This requires mapping and storage of the Object |
| | to potentially non-object oriented systems such as DB2. |
| Enterprise | A standard structure for all Enterprise Objects to ensure the |
| Object | integrity of an Object throughout its lifecycle. |
| Relationship | A mechanism for breaking up Object Graphs into simpler |
| Management | components by making object relationships indirect. This |
| | makes the transmission of Objects over the network easier |
| | and avoids cyclic references. |

TABLE 3
Infrastructure Services

| | |
|---|---|
| ASF | Description |

Security Services

| | |
|---|---|
| Authentication | A mechanism for verifying credentials of a user for the |
| | purpose of identification and non-repudiation. |
| Authorization | A role-based mechanism for denying or authorizing |
| | access to resources in the SOA. |
| Encryption/Decryption | Encryption/Decryption algorithms and implementation |
| | necessary as an additional capability to conform to |
| | HIPAA standards. |

Other Infrastructure Services

| | |
|---|---|
| Business Rules Engine | This refers to the externalization of Business Rules via |
| | the ILOG engine as it applies in the SOA. |
| Content Management | Content Management is responsible for managing |
| | documents (not limited by type) throughout their lifecycle |
| | including creation, formatting, storage, retrieval and |
| | destruction. |
| Channel and Delivery | A mechanism for transmitting correspondence to clients |
| | and partners that includes Mail, Telephony, Short |
| | Message Services (SMS), E-mail, and other transports in |
| | conjunction with a means of delivery to specific contacts |
| | and partners. This may be Business-to-Business or |
| | Buiness-to-End-User |

TABLE 4
Architecture Tiers

| ASF | Description |
|---|---|
| Presentation | A framework for presenting information to the End |
| | User and collecting input. |
| Business-Process | Business-Process Management provides a |
| | mechanism by which |
| Management | Workflow is choreographed and processed and |
| | is an application of IBM's Websphere Business |
| | Integration suite. |

TABLE 5
Patterns

| ASF | Description |
|---|---|
| Facet-Design Pattern | A design pattern for layering functionality of the |
| | architecture in an unobtrusive way. |

A flexibility-enhancing component of the service-invocation framework 26, 28 includes runtime integration with the Universal Discovery Description Integration (UDDI)-based registry 24 to retrieve definitions pertaining to the service providers 92 and other meta-data definitions. This facilitates providing requesters 64 with location, transport, and protocol transparency. The requesters 64 do not require knowledge of how a given service is provided by a provider 92. This so-called loose coupling between the requesters 64 and the providers 92 promote maximum flexibility for implementing the providers 92 and the requesters 64. This loose coupling further facilitates optimizing existing applications, such as when an alternative service implementation is required to fulfill certain requirements, such as throughput or latency.

The service-invocation framework 26, 28 may include request handlers for Remote Method Invocation using Internet Inter-Object-request-broker Protocol as the transport protocol (RMI/IIOP), SOAP, JMS. The SF module 26 can be used to invoke synchronous and/or asynchronous services.

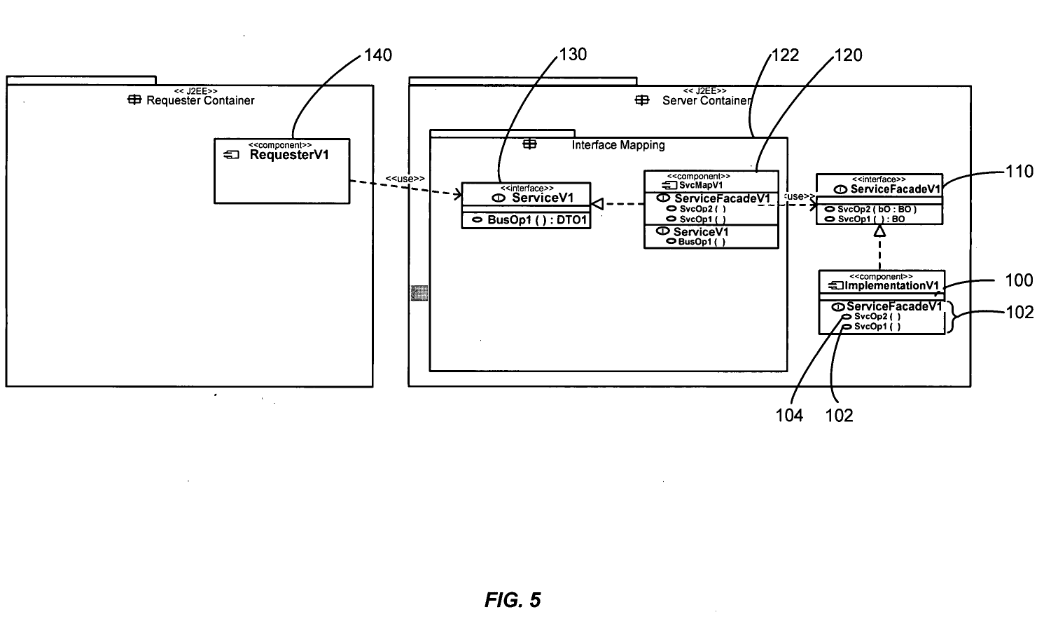

FIGS. 5-7 illustrate a service interface pattern (SIP) used to provide an interface abstraction layer for a service provider. This approach allows changes to be made to the service provider implementation without necessarily requiring changes in the way the service consumer requests services from the service provider.

FIG. 5 illustrates an initial deployment of a service interface pattern with static binding and an initial version of the service implementation component 100, called ImplementationV1. In FIG. 5, ImplementationV1 implements ServiceFacadeV1 102 and its service operations SvcOp2 104 and SvcOp1 106. The operations are exposed to mapping container 122 via ServiceFacadeV1 interface 110. SvcMapV1 component 120 implements the ServiceV1 interface 130 and maps its operations and data transfer objects (DTO) to the ServiceFacadeV1 interface 110.

ServiceFacadeV1 110 uses business objects (BO) or “enterprise objects” as arguments and/or return values. Typically, service providers expose business operations on their interfaces and interact by exchanging data transfer objects, also known as value objects. The service implementation 100 operates on and maintains business objects, which typically contain many more attributes and object dependencies than are needed to satisfy a request using data transfer objects. Additionally, new requirements often mandate changes to ServiceFacade 110 and underlying service implementation 100. In FIG. 5, RequesterV1 component 140 is a service requester that operates with data transfer objects and accesses services via an interface such as ServiceV1 interface 130.

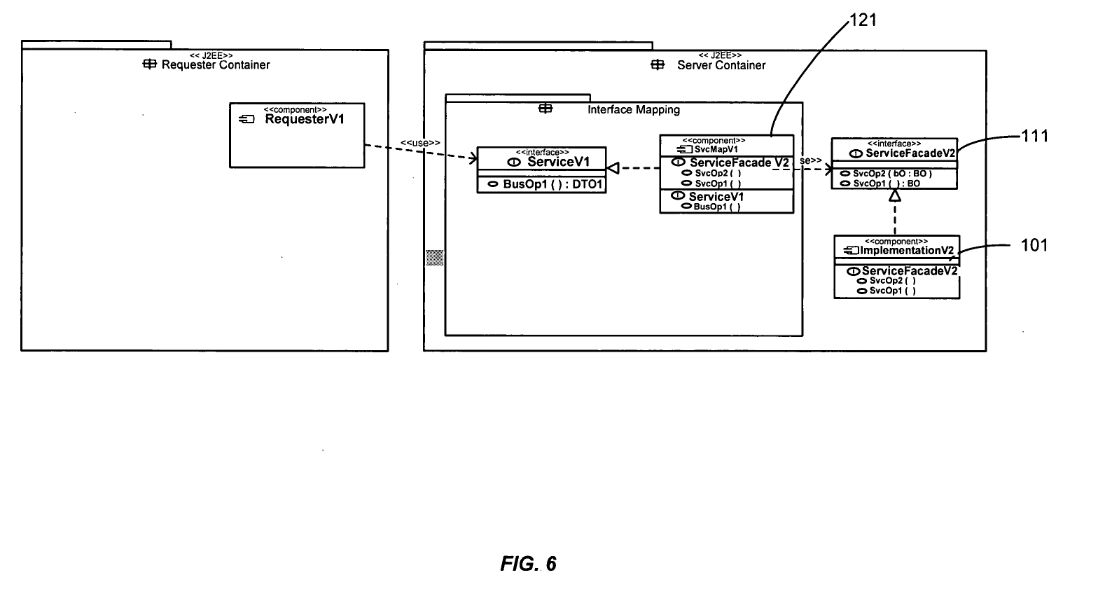

FIG. 6 shows the same components and interfaces of FIG. 5 after the service implementation has changed. This can be due to customer requirements, manufacturer updates, patches or changes to applications, etc. In FIG. 6, ImplementationV2 101 now uses ServiceFacadeV2. This requires changing the service facade interface ServiceFacadeV2 111. SvcMapV1 121 is also modified to use ServiceFacadeV2 so that ServiceV1 maps to ServiceFacadeV2.

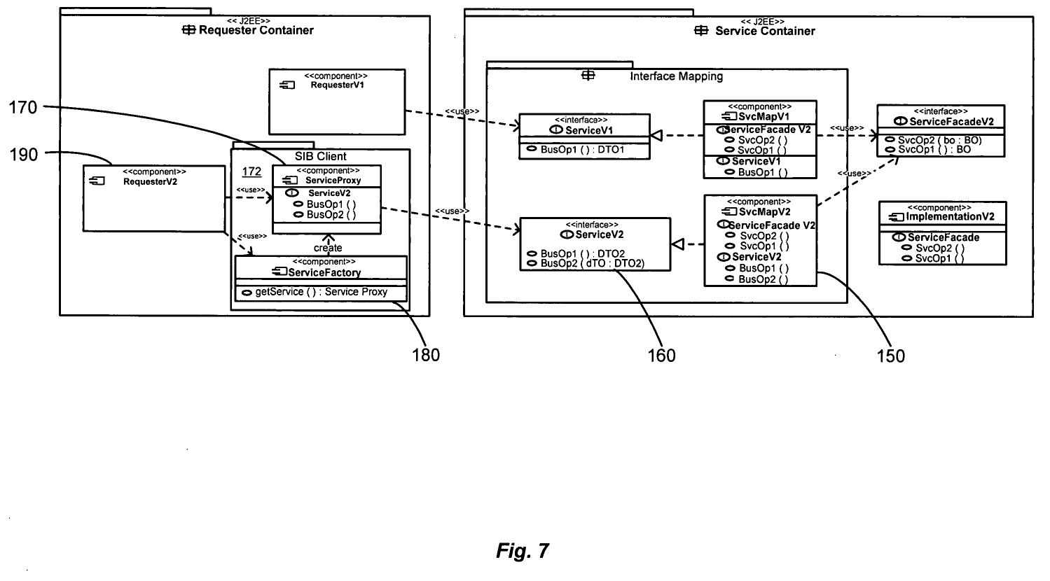

In FIG. 7, a new service mapping for new RequesterV2 190 has been added. By adding a new mapping with this approach, service requesters using the original service provider need not be impacted by changes to service facades or service implementations. New mappings can be added if new service requesters need to be supported, custom interfaces are used by applications, or for other reasons.

In FIG. 7, SvcMapV2 component 150 and ServiceV2 interface 160 are used to provide a mapping between data transfer objects and enterprise objects for new service requesters using the new features of the service implementation 100, similar to the mapping described above with respect to FIG. 5. Note that although specific service providers and requesters may be discussed to illustrate specific examples or embodiments, in other embodiments any number and type of requesters and providers can be employed.

In FIG. 7, a new service requester is represented by RequesterV2 190, which uses a new service implementation through the ServiceV2 interface 160. EnhancedRequester 190 illustrates how the SIBClient package 172 is used to dynamically bind to ServiceV2. Basically, the EnhancedRequester instructs the ServiceFactory to get a new service. The ServiceFactory queries the registry for the service definition (WSDL) of the requested service and parses the WSDL to create a ServiceProxy with the correct binding for the service. The ServiceFactory returns the ServiceProxy to the ServiceRequester, which then uses the ServiceProxy to access the service provider as described above.

The interface and data mapping capability provided by interface patterns, such as shown in FIGS. 5-7, is usually supported by tooling. Tooling allows automated creation of the mapping components. This helps to optimize the development process of mapping between enterprise objects and data transfer objects. When changes occur to a ServiceFacade, such as the addition of new attributes to an enterprise object, or when new operations are added to the ServiceFacade, the service interface exposed on the service integration bus need not be impacted. Mappings can be changed to accommodate broader changes to the ServiceFacade that require remapping for the original requester. Service interfaces for new requesters that wish to take advantage of the new capabilities supported by the service implementation can be introduced, and modifications to older DTOs for the new requester can be supported.

A ServiceFacade provides an interface definition for a service that exposes a mapping abstraction to the service that is at a higher (“coarser-grained”) level than the service's “native” interface. Typically, the higher level interface uses operations defined on business objects or enterprise objects that are not directly exposed to requesters or interfaces on the SIB. The mapping abstraction layer provides mapping to DTOs and simplifies the interface exposed on the SIB. The mapping abstraction layer also insulates service requesters from service version changes.

Although embodiments of the invention are discussed primarily with respect to consumer-producer architecture, any acceptable architecture, topology, protocols, or other network and digital processing features can be employed. In general, network controllers, managers, access points, endpoints, clients, and so on, can be implemented via any device with processing ability or other requisite functionality.

Although processes of the present invention and the hardware executing the processes may be characterized by language common to a discussion of the Internet (e.g., “client,” “server,” “peer”), it should be apparent that operations of the present invention can execute on any type of suitable hardware in any communication relationship to another device on any type of link or network.

Although a process of the present invention may be presented as a single entity, such as software executing on a single machine, such software can readily be executed on multiple machines. That is, there may be multiple instances of a given software program, a single program may be executing on two or more processors in a distributed processing environment, parts of a single program may be executing on different physical machines, etc. Furthermore, two different programs, such as a requester and provider program, can be executing in a single machine, or in different machines. A single program can be operating as a client for one information transaction and as a server for a different information transaction.

Any type of processing device can be used as a client or consumer. For example, portable computing devices such as a personal digital assistant (PDA), cell phone, laptop computer, or other devices can be employed. In general, the devices and manner of specific processing (including location and timing) are not critical to practicing important features of the present invention.

Although the invention has been discussed with respect to specific embodiments thereof, these embodiments are merely illustrative, and not restrictive, of the invention. Embodiments of the present invention can operate between any two processes or entities including users, devices, functional systems, or combinations of hardware and software. Peer-to-peer networks and any other networks or systems where the roles of client and server are switched, change dynamically, or are not even present are within the scope of the invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented in whole or in part by using a programmed general purpose digital computer; by using application specific integrated circuits, programmable logic devices, field programmable gate arrays, optical, chemical, biological, quantum or nanoengineered systems or mechanisms; and so on. In general, the functions of the present invention can be achieved by any means as is known in the art. Distributed or networked systems, components, and/or circuits can be used. Communication, or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A Service-Oriented Architecture (SOA) comprising:
a first tier, which includes a requester of a service;
a second tier, which includes a provider of a service; and
a first layer interfacing the first tier and the second tier, wherein the first layer includes
a registry adapted to store information pertaining to the service; and
a first module adapted to employ the information to facilitate interaction between the requester and the provider.

2. The SOA of claim 1, wherein the first module includes:
a Service Factory (SF).

3. The SOA of claim 2, wherein the information includes:
a definition of the service.

4. The SOA of claim 2, wherein the service factory includes:
runtime binding functionality for associating the service requested by the requester with a proxy, wherein the proxy is adapted to interface the requester with the provider, thereby obviating the need for the requester to be specifically modified to accept services directly from the provider.

5. The SOA of claim 2, wherein the service factory includes:
a service-invocation module for selectively invoking the service in response to a request issued by the requester.

6. The SOA of claim 2, wherein the requester includes:
a first legacy system.

7. The SOA of claim 6, further including:
a first business integration module interfacing the first legacy system with the registry.

8. The SOA of claim 2, wherein the provider includes:
a second legacy system.

9. The SOA of claim 8, further including:
a second business integration module interfacing the second legacy system with the registry.

10. The SOA of claim 2, wherein the first layer further includes:
a service router adapted to facilitate publishing the information to the registry.

11. The SOA of claim 2, wherein the proxy includes:
a programming object.

12. The SOA of claim 1, wherein the first layer includes:
a Service Integration Bus (SIB).

13. The SOA of claim 12, wherein the SIB includes:
a Service Gateway (SG).

14. The SOA of claim 13, wherein the SG includes:
one or more routines for performing runtime mediation for one or more requesters that include one or more consumers of a Web service, to enable the consumers to employ a service that is not a Web service.

15. The SOA of claim 14, wherein the SIB further includes:
a service-management module adapted to monitor and/or manage one or more service providers.

16. The SOA of claim 14, wherein the SIB further includes:
a first versioning module for selectively controlling which version of a service a specific service requester employs in response to a service request.

17. The SOA of claim 12, further including:
a business-process services tier.

18. The SOA of claim 17, wherein the first tier includes:
a consumer tier, and wherein the second tier includes a producer tier.

19. The SOA of claim 18, wherein the business-process services tier includes:
one or more modules adapted to manage communications between the consumer tier and the producer tier.

20. The SOA of claim 18, further including:
an infrastructure-services tier.

21. The SOA of claim 20, further including:
a persistence layer coupled between the consumer tier, the producer tier, and the infrastructure-services tier.

22. The SOA of claim 21, wherein the persistence layer includes:
versioning functionality.

23. The SOA of claim 21, wherein the persistence layer further includes:
a content management module, and wherein the content management module is further incorporated in the infrastructure-services tier.

24. The SOA of claim 23, wherein the persistence layer further includes:
a relationship-management module.

25. The SOA of claim 23, wherein the persistence layer further includes:
a data-integration module.

26. The SOA of claim 21, wherein the consumer tier includes:
a first business-integration layer or module adapted to facilitate interfacing one or more service requesters with one or more service providers.

27. The SOA of claim 26, wherein the one or more service requesters include:
one or more legacy applications.

28. The SOA of claim 21, wherein the producer tier includes:
a second business-integration layer or module adapted to facilitate interfacing one or more service providers with one or more service requesters.

29. The SOA of claim 28, wherein the one or more service providers include:
one or more legacy applications.

30. A Service-Oriented Architecture (SOA) comprising:
a first tier that includes a consumer;
a second tier that includes a producer; and
an interface between the consumer and the producer, wherein the interface includes:
a service-invocation tier and
a service interface in communication with the service-invocation tier.

31. The SOA of claim 31, wherein the interface includes a Service Integration Bus (SIB), which includes the service-invocation tier and the service interface.

32. The SOA of claim 31, further including:
a registry in communication with the service interface.

33. The SOA of claim 32, wherein the registry includes:
one or more definitions published by one or more producers, wherein the one or more producers are included in the second tier.

34. The SOA of claim 33, wherein the definitions include:
Web Services Definition Language (WSDL).

35. The SOA of claim 33, wherein the one or more definitions include:
one or more of the following types of definitions:
Web-Service (WS);
Enterprise Java Beans (EJB);
Java Messaging Services (JMS);
Java 2 Enterprise Edition (J2EE) for WS, EJB, JMS, and/or J2EE services, respectively.

36. The SOA of claim 31, wherein the interface further includes:
first means for determining information associated with a service offered by the producer and
second means for employing the information when the service is implemented to create an entity with which the consumer may communicate without directly communicating with the producer.

37. The SOA of claim 36, wherein the entity includes:
a proxy.

38. The SOA of claim 37 wherein the proxy is adapted for use by a service requester.

39. The SOA of claim 37, wherein the first means includes:
a service-invocation module in communication with a registry.

40. The SOA of claim 36, wherein the second means includes:
a Service Factory (SF).

41. The SOA of claim 40, wherein the SF includes:
a runtime binding module.

42. The SOA of claim 31, wherein the bus includes:
a Service-Integration Bus (SIB)

43. The SOA of claim 42, wherein the SIB includes:
the interface.

44. The SOA of claim 43, wherein the SIB includes:
a business-integration tier, wherein the business-integration tier interfaces one or more consumer legacy applications with one or more services, and/or interfaces one or more producer legacy applications with one or more consumers.

45. The SOA of claim 31, wherein the one or more consumers include:
zero or more consumer legacy applications.

46. The SOA of claim 31, wherein the one or more producers include:
zero or more producer legacy applications.

47. A Service-Oriented Architecture (SOA) comprising:
one or more service consumers;
one or more service producers;
a bus coupled between the one or more service consumers and the one or more service producers, wherein the bus includes
runtime binding functionality to facilitate interaction between the one or more service requesters and the one or more service providers; and
a registry in communication with the one or more service requesters and the bus.

48. The SOA of claim 47, wherein the one or more service producers communicate with the registry.

49. The SOA of claim 47, wherein the bus includes:
a Service-Integration Bus (SIB).

50. The SOA of claim 49, wherein the SIB includes:
a Service-Factory (SF) module.

51. The SOA of claim 49, wherein the SF module includes:
first means for selectively invoking a service provided by a service producer in response to a request from a service consumer.

52. The SOA of claim 51, wherein the first means further includes:
a runtime binding module in communication with a dynamic service-invocation module.

53. The SOA of claim 49, wherein the SIB further includes:
a Service Gateway (SG).

54. The SOA of claim 49, wherein the runtime binding functionality includes:
second means for associating requests from the one or more service consumers with one or more services provided by the one or more services producers.

55. The SOA of claim 47, wherein the one or more service consumers include:
a legacy consumer that includes a first legacy application.

56. The SOA of claim 55, further including:
a first business-integration layer or module coupled between the first legacy application and a service producer.

57. The SOA of claim 56, wherein the first business-integration layer or module is coupled between the first legacy application and the SIB, wherein the SIB is coupled between the legacy consumer and the service producer.

58. The SOA of claim 47, wherein the one or more service producers include:
a legacy producer that includes a second legacy application.

59. The SOA of claim 58, further including:
a second business-integration layer or module coupled between the second legacy application and the SIB.

60. A Service-oriented architecture (SOA) comprising:
a service requester;
a service provider;
a registry; and
a Service Integration Bus (SIB) interfacing the service requester, the service provider, and/or the registry, wherein the SIB includes a Service-Factory module.

61. The SOA of claim 60, wherein the SF module is in communication with the registry.

62. The SOA of claim 61, wherein the registry includes:
published information pertaining to services published by the service provider.

63. The SOA of claim 62, wherein the published information includes:
service definitions.

64. The SOA of claim 63, wherein the service definitions are specified via Web Services Design Language (WSDL).

65. The SOA of claim 61, wherein the SF includes:
a runtime-binding module capable of facilitating runtime binding of services with the published information.

66. The SOA of claim 65, wherein the runtime-binding module implements consumer-side runtime binding.

67. The SOA of claim 61, wherein the SF includes:
a service-invocation module.

68. The SOA of claim 61, wherein the SIB further includes:
a service gateway.

69. The SOA of claim 68, wherein the service gateway includes:
one or more routines for providing mediation to shield a consumer from one or more implementation details of a service.

70. A method for implement a Service-Oriented Architecture (SOA) comprising:
interfacing one or more service requesters with one or more service providers via a bus;
implementing runtime binding functionality in the bus to facilitate interaction between the one or more service requesters and the one or more service providers; and
using a registry to communicate information pertaining to the one or more services requesters and/or the one or more service providers to the bus.

71. A method for designing a software system, the method comprising:
defining one or more tiers, wherein a tier organizes one or more service requestors or service providers; and
defining one or more layers, wherein a layer acts as an interface for an exchange of information within the software system.

72. The method of claim 71, wherein a tier includes:
a presentation services tier.

73. The method of claim 71, wherein a tier includes:
a business process services tier.

74. The method of claim 71, wherein a tier includes:
a business services tier.

75. The method of claim 71, wherein a tier includes:
an infrastructure services tier.

76. The method of claim 71, wherein a layer includes:
a service integration bus.

77. The method of claim 6, wherein the Service Integration Bus includes:
an open source implementation.

78. The method of claim 7, wherein the open source implementation includes:
Web Services Invocation Framework.

79. The method of claim 71, wherein a layer includes:
a persistence layer.

80. The method of claim 71, wherein a layer includes:
a business registry.

81. A method for designing a software system, the method comprising:
defining four tiers, wherein a tier organizes one or more service requestors or service providers, wherein the tiers include infrastructure services, business services, business process services, and presentation services; and
defining four layers, wherein a layer acts as an interface for an exchange of information within the software system, wherein the layers include a persistence layer using enterprise object management, a service integration bus, a registry and a business integration layer.

82. A method for designing a software system, the method comprising:
defining four tiers, wherein a tier organizes one or more service requesters or service providers, wherein the tiers include infrastructure services, business services, business process services, and presentation services; and
defining two or more layers, wherein a layer acts as an interface for an exchange of information within the software system, wherein the layers include a persistence layer and a service integration bus.

83. A method for implementing a service for use by a requester in a service oriented architecture, the method comprising:
establishing an interface mapping, wherein the interface mapping translates a request from the requester and provides the request to the service.

84. The method of claim 83, wherein providing the request to the service includes:
defining a service facade derived from information provided by the service.

85. The method of claim 83, wherein the request from the requestor includes a data transfer object.

86. The method of claim 83, wherein the request is provided to the service by using a business object.

87. A method for handling a request for a particular service, wherein the request is made by a requester, the method comprising the following steps executed by a processor:
using an interface mapping to receive the request;
mapping the request to a service facade, wherein the service facade is associated with the particular service; and
using the particular service to provide the request.

88. The method of claim 87, wherein the interface mapping includes a service interface and a copy of the service facade.

89. The method of claim 87, wherein the requester obtains services from the particular service via a predetermined requesting procedure, the method further comprising:
determining that a service facade associated with the particular service has changed; and
modifying a copy of the service facade within the interface mapping so that the requester does not have to modify the predetermined requesting procedure in order to continue to obtain the particular service.

90. The system as substantially described herein.
